(19) United States
(12) Patent Application Publication
(10) Pub. No.: US 2015/0337781 A1
(43) Pub. Date: Nov. 26, 2015

(54) Diesel Gaseous Fuel Supplementation System and Method

(71) Applicant: Patrick W. Hartwick, Sugar Land, TX (US)

(72) Inventor: Patrick W. Hartwick, Sugar Land, TX (US)

(21) Appl. No.: 14/284,344

(22) Filed: May 21, 2014

(51) Int. Cl. F02M 51/06

(52) U.S. Cl. CPC F02M 51/06

(57) ABSTRACT

A system and process for supplementing diesel engine diesel fuel supply with gaseous fuel that employs a sensor system, a control module, and an adjustment system to detect impending pre-detonation fluctuations and adjust the operational settings in order to maintain operation in non-pre-detonation mode.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

1. Field of the Invention

This invention generally relates to the field of diesel engine, and more specifically to a system for controlling the introduction of supplementary gaseous fuel into a diesel system.

2. Description of the Related Art

Engine manufacturers, aftermarket suppliers and private individuals have been supplemented the diesel fuel in diesel engines with various forms of gaseous fuels for some time. The reason for doing this is to reduce fuel cost to operate the engine. There are other perceived benefits derived from supplementing diesel fuel with gaseous fuels that may include increased engine life, reduced engine maintenance and reduced exhaust emissions.

An inherent danger of supplementing diesel fuel with gaseous fuels in a diesel engine is having the engine enter into detonation. Detonation is when the speed of the flame front in the combustion chamber exceeds the speed of sound, which causes a sonic boom to take place in the combustion chamber. When the sonic boom takes place the sound/energy waves from it bounce back and forth between the various components comprising the combustion chamber. This is the pinging sound heard when an engine detonates. More important than the sound is a tremendous increase in cylinder pressure from the rapid burning of the remaining fuel in the cylinder. The high frequency sound/energy waves and the tremendous increase in cylinder pressure shorten engine life. It is possible for severe detonation to reduce an engine's life to just a few minutes.

The blending of a gaseous fuel into a diesel engine may be seen as relatively simple in an application where the engine operates at a constant speed and load, the ambient conditions never change and the heat value of the gaseous fuel remains constant. For such an application the control of the flow of the gaseous fuel would require nothing more than a ball valve locked in place to yield a constant flow. To determine what the flow should be one would add the gaseous fuel until they hear detonation, and then reduce flow until detonation goes away. At this flow supplementation of the diesel fuel is maximized without damage to the engine. A couple examples of systems adapted to supply a diesel engine with diesel fuel supplemented with a fuel gas, for operation in relatively a stable environment, are described in U.S. Pat. Nos. 6,250,260 and 6,543,395, filed on 26 Jun. 2001 and 8 Apr. 2003, respectively.

However, in the real world there is constant change. Most engine applications see constant load and speed changes. Ambient conditions are never constant, and the heat value of the fuel can widely vary, even change minute-to-minute in the case of raw well head gas as the supplemental fuel. It would therefore be a valuable addition to the art to have a system that maximizes the amount of gaseous fuel going into the diesel engine while keeping the engine out of detonation.

### BRIEF DESCRIPTION OF THE DRAWINGS

The invention will be explained in conjunction with an illustrative embodiment shown in the accompanying drawings, in which:

FIG. 1a is a schematic illustration of an exemplary gaseous fuel supplementation system;

FIG. 1b is a schematic illustration of diesel engine configured with an exemplary gaseous fuel supplementation system;

FIG. 2 is an illustration of a typical pressure trace of the combustion chamber for a diesel engine running on diesel fuel at a constant speed and load;

FIG. 3 is an illustration of a typical pressure trace of the combustion chamber for a diesel engine running on a mixture of diesel and gaseous fuel, experiencing detonation;

FIG. 4 is an illustration of a typical pressure trace of the combustion chamber for a diesel engine running on a mixture of diesel and gaseous fuel, without detonation;

FIG. 5 is an enlarged illustration of Box A of the peak of the pressure trace in FIG. 4, illustrating the range of peak pressure variations experienced in the combustion chamber;

FIG. 6 is an illustration of a pressure trace of the combustion chamber for a diesel engine running on a mixture of diesel and gaseous fuel controlled by the current system in order to control detonation and keep the operating pressure within the typical, non-detonation pressure range;

FIG. 7 is an enlarged illustration of Box B of the peak of the pressure trace in FIG. 6, illustrating the range of peak pressure variations that occur in the combustion chamber as the system adjusts the combustion to avoid detonation; and

FIG. 8 is flow diagram of an exemplary process of the current system.

FIG. 9 is a flow diagram of an alternate exemplary process of the current system.

### DESCRIPTION OF THE ILLUSTRATED EMBODIMENT

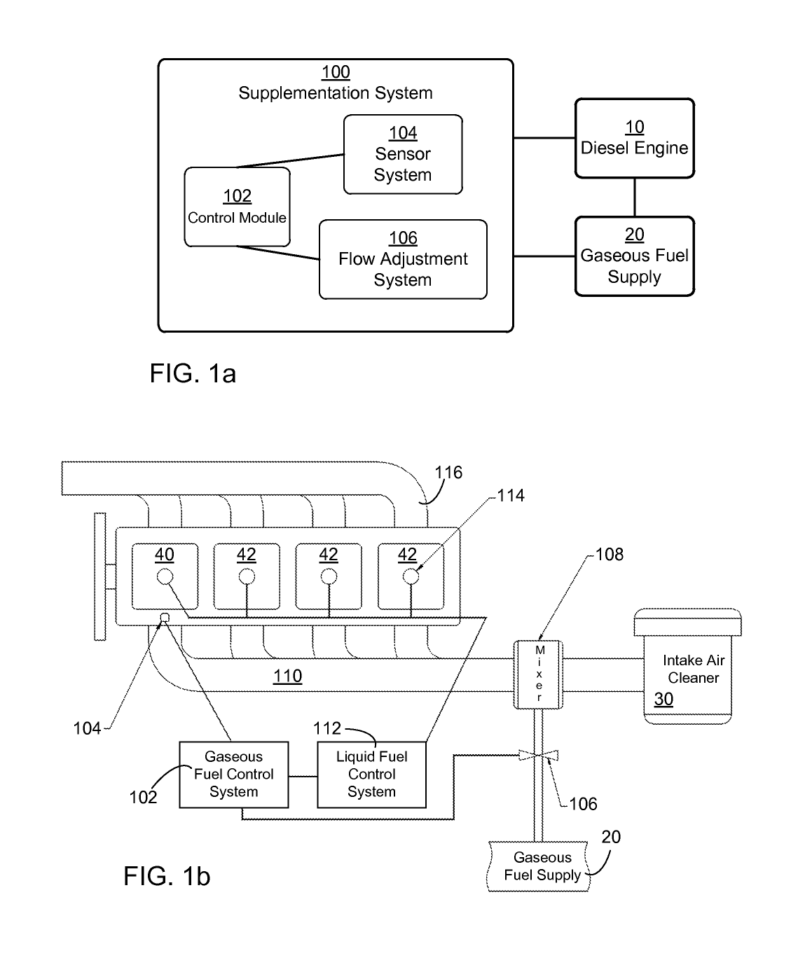

Now, referring to FIGS. 1a and 1b, the supplementation system 100 is operatively linked to a diesel engine 10 and gaseous fuel supply 20. An exemplary supplementation system 100 is shown to have a gaseous fuel control module 102 that is operatively linked to a sensor system 104 and the gaseous fuel flow adjustment system 106. The gaseous fuel control module 102 is configured to receive input from various sensors of sensor system 104. The exemplary sensor system 104 includes an engine combustion chamber pre-ignition sensor. In the exemplary embodiment, the pre-ignition sensor is a pressure sensor, but other types of sensors may be used to detect the engine transitioning into pre-ignition, such as a vibration sensor. The CPS-01 cylinder pressure sensor, by imes GmbH, of Germany, is an exemplary sensor that one might use. The sensor system 104 may include other sensors, such as a gaseous fuel flow sensor, an engine load sensor, an air flow sensor, an engine speed sensor, and the fuel quality sensor.

A gaseous fuel supply 20 is operatively linked to the gaseous fuel flow adjustment system 106 to provide a supply of gaseous fuel for combustion supplementation. Gaseous fuel flow adjustment system 106 controllably provides a supply of gaseous fuel to a gaseous fuel mixer 108, which combines a supply of combustion air from intake air cleaner 30. The combination of gaseous fuel and combustion air is in fluid communication with the cylinders (40, 42) via intake manifold 110. At the same time during the operation of engine 10, a liquid fuel control system 110 controls a supply of liquid fuel to cylinders (40, 42) via injectors 114. The combustion exhaust from the system is released from the cylinders (40, 42) via exhaust manifold 116.

The gaseous fuel control module 102 is configured to process signals representative of particular conditions received from the sensor system 104. The gaseous fuel control module 102 uses these signals to determine what adjustments need to be made to the combustion parameters associated with the engine. The gaseous fuel control module 102 provides determined instructions to the gaseous fuel flow adjustment system 106 to make the appropriate adjustments as a response to the conditions detected by sensor system 104. Supplementation system's 100 adjustments to the engine 10 keep the engine 10 out of detonation, yet using a maximum amount of gaseous fuel supplementation.

Referring now to FIG. 2, a typical pressure trace of the combustion chamber for a diesel engine running on diesel fuel at a constant speed and load is shown to be consistent. The lower left-hand corner of the figure depicts the piston is positioned at the bottom dead center (“BDC”) of the cylinder. Pressure in the combustion chamber is minimal. As the chart progresses from left to right the piston moves upward in the combustion chamber, from BDC to top dead center (“TDC”). Pressure curve 200 shows that as the piston moves upward, pressure in the combustion chamber builds. Typically, diesel fuel is injected into the combustion chamber just before the piston arrives at TDC. The fuel immediately starts combustion, causing pressure within the cylinder to rise rapidly. Initial peak firing pressure point 202 is the point in the piston travel cycle where peak firing pressure is reached. Initial peak firing pressure point 202 is typically at about 15° after TDC. Pressure within the cylinder stays at a peak pressure range for a peak pressure range duration 204 before declining back to the minimal pressure environment at BDC, shown in the bottom right of the figure.

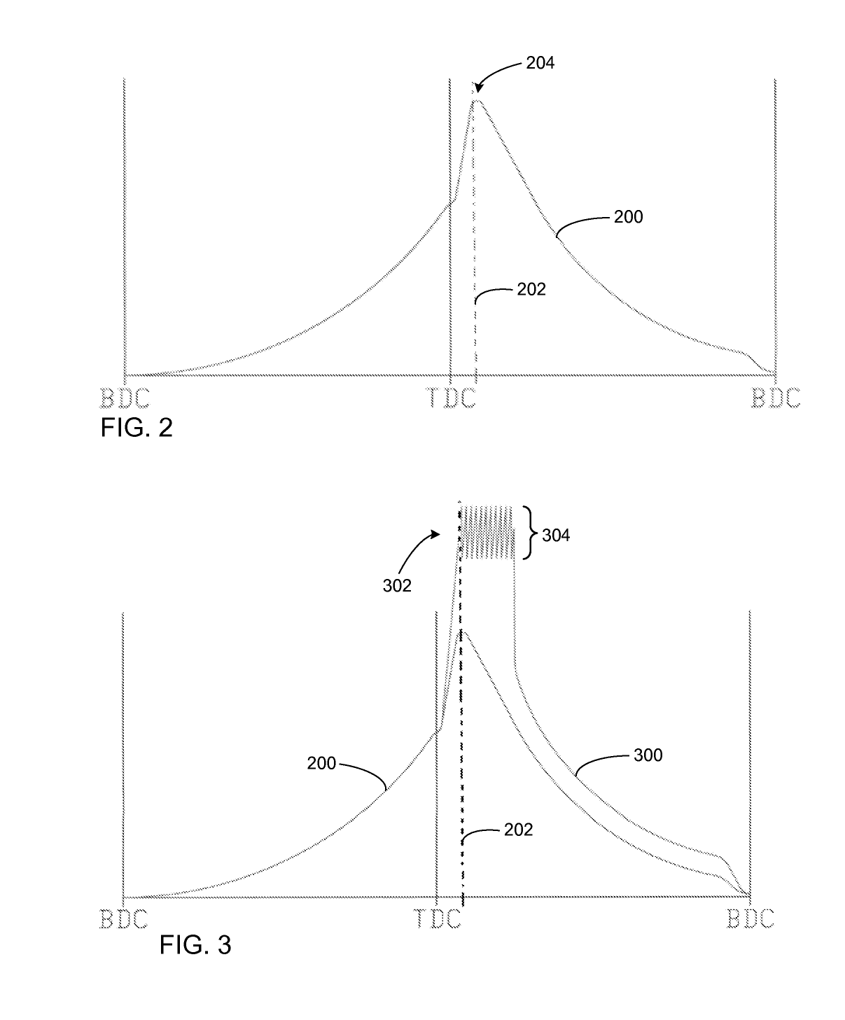

Referring now to FIG. 3, a typical detonation pressure curve 300 is shown superimposed over the standard pressure curve 200. The two curves diverge after fuel is introduced into the cylinder. The detonation pressure level and vibration amplitude 302 are substantially higher by the time the cylinder reaches the peak firing pressure point 202. Additionally, significant pressure fluctuations 304 create damaging shockwaves with in the combustion chamber.

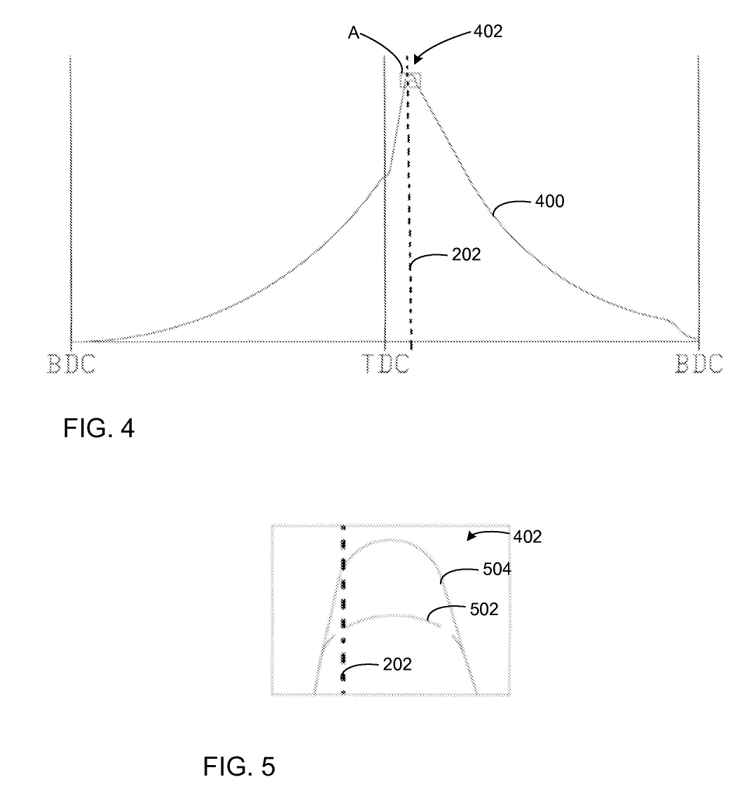

Referring now to FIGS. 4 and 5, a typical gaseous fuel supplemented detonation curve 400, where diesel fuel is supplemented by gaseous fuel in a control system, is shown, which looks very similar to the typical straight-diesel pressure curve 200. This situation is where the diesel engine is running in stable conditions, such as uniforms speed and load, with uniform air and fuel flow, and a uniform fuel heat value. Peak pressure levels 402 occur at a similar peak firing pressure point 202, at varying levels of pressure between piston cycles. In some cycles lower peak pressure curve 502 will be attained while on other cycles higher peak pressure curve 504 will be attained. It is believed that the variations are at least in part caused by an imperfect air fuel ratio, since a homogeneous mixture, essential to uniform combustion, is difficult to attain with the gaseous fuel.

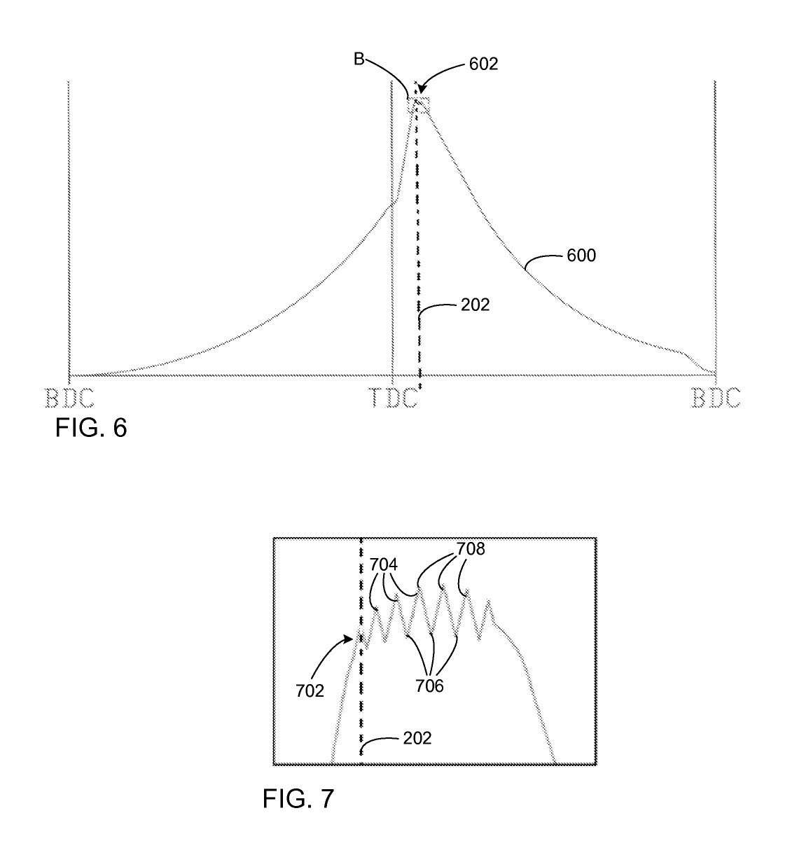

Referring now to FIGS. 6 and 7, an exemplary controlled combustion pressure curve 600 looks very similar to the typical straight-diesel pressure curve 200 and gaseous fuel supplemented detonation curve 400. The current system succeeds in maintaining engine operation at the exemplary controlled peak pressure levels 602 similar to those found in gas fuel supplemented the pressure levels 402, while adjusting to varied operational condition, such as speed, load, air or fuel flow and unpredictable fuel heat value. As with previous gas fuel supplemented system, the exemplary controlled system approaches peak firing pressure levels 702, a number of very small but rapid pressure spikes 704 occur. These rapid pressure spikes 704 are indicative of impending detonation. In response, supplementation system 100 makes adjustments to the engine operation. The adjustments control pressure levels within the combustion chamber. Combustion is maintained, but it is controlled in between acceptable low pressures 706 and acceptable high pressures 708 until the standard combustion period is complete and the pressure levels within the combustion chamber declined.

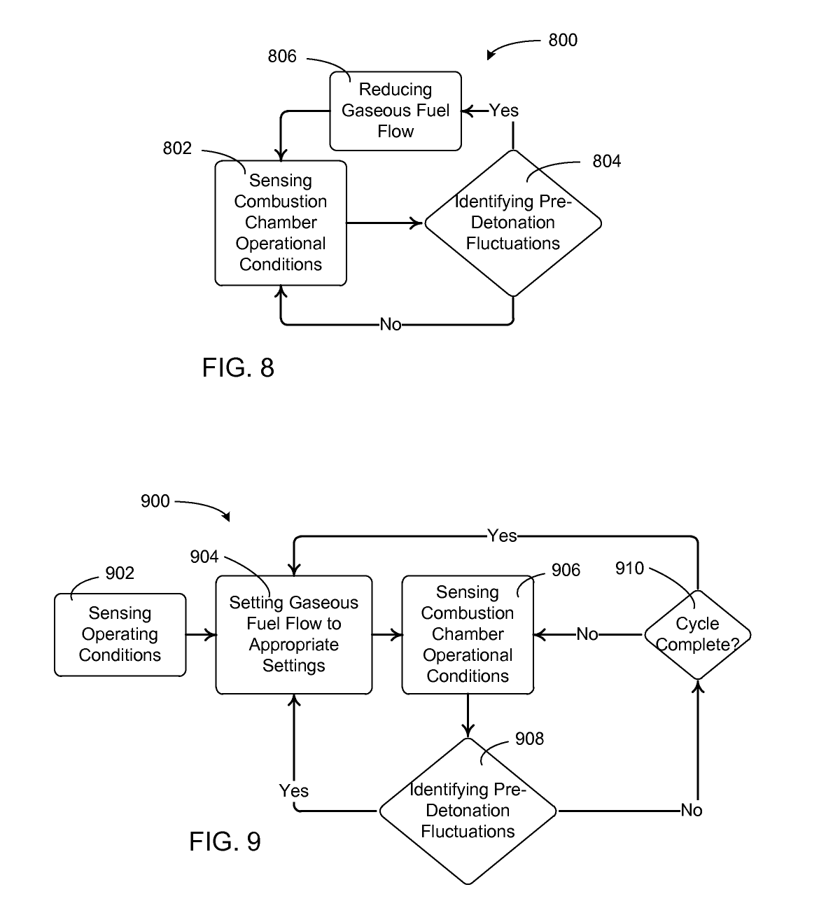

Referring now to FIG. 8, the exemplary adjustment process 800 depicts how a supplementation system 100, when activated, adjusts engine operations once impending detonation is detected. During engine operation supplementation system 100 continually senses combustion chamber operational conditions 802 with sensor system 104. In the exemplary embodiment, pressure levels detected by sensor system 104 are relayed to control module 102. In an alternate exemplary embodiment, vibration levels detected by sensor system 104 are relayed to control module 102. Control module 102 assesses data regarding the operational conditions of a combustion chamber, such as the pressure level, to identify pre-detonation fluctuations 804. If pre-detonation fluctuations are identified by control module 102, control module 102 sends appropriate signals to adjustment system 106 to reduce gaseous fuel flow.

Referring now to FIG. 9, the exemplary adjustment process 900 depicts how a supplementation system 100, when activated, monitors total system conditions 902 with sensor system 104. One or more of the sensed condition are relayed to the control module 102. Given the current conditions, control module 102 determines the appropriate settings for the supplementation system 100. Such settings are configured to anticipated levels 904 within the engine 10 and gaseous fuel supply 20 by the adjustment system 106. During engine operation sensor system 104 continues to monitor various conditions. In particular, exemplary sensor system 104 monitors combustion chamber operational conditions 906 to identify pre-detonation fluctuations 908. If pre-detonation fluctuations are identified control module 102 adjusts the appropriate settings, and reconfigures the appropriate settings of engine 10 in gaseous fuel supply 20. In the exemplary system control module's 102 appropriate settings would include adjustment of the gaseous fuel flow with adjustment system 106.

If no pre-detonation fluctuations are identified, control module 102 determines if the combustion cycle is complete 910. If not, combustion chamber operational conditions sensing 906 continues. If the cycle is complete, control module 102 reassesses the data received from sensor system 104 and determines the appropriate settings for continued operation of supplemental system 100 and corresponding engine 10.

The foregoing disclosure and description of the invention is illustrative and explanatory thereof. Various changes in the details of the illustrated construction may be made within the scope of the appended claims without departing from the spirit of the invention. The present invention should only be limited by the following claims and their legal equivalents.

I claim:

1. A gaseous fuel supplementation system for a diesel engine comprising:
a control module operatively connected to a sensor system and an gaseous fuel flow adjustment system;
the sensor system configured to detect pre-detonation data operatively connected to at least one cylinder of the engine, and configured to relay pre-detonation data to the control module;
the control module configured to identify impending pre-detonation from the pre-detonation data, determine corrective action and relay corrective action instructions to the gaseous fuel flow adjustment system; and
the gaseous fuel flow adjustment system configured to use the corrective action instructions to adjust a flow of a gaseous fuel to the engine.

2. The system of claim 1 further comprising:
the sensor system configured to sense pressure fluctuations in a cylinder of the engine.

3. The system of claim 1 further comprising:
the sensor system having a vibration sensor operatively connected to a cylinder of the engine.

4. The system of claim 1 wherein the sensor system further comprising:
a pressure sensor operatively connected to a cylinder of the engine.

5. The system of claim 1 further comprising:
the sensor system configured to sense vibration fluctuations in a cylinder of the engine.

6. The system of claim 1 further comprising:
the engine operating parameters configured such that a cylinder of the at least one cylinder of the engine is more susceptible to pre-ignition than other cylinders of the engine.

7. The system of claim 1 wherein:
the corrective action instructions to reduce a flow of a gaseous fuel to the engine.

8. The system of claim 1 further comprising:
the sensor system comprising a pressure sensor operatively connected to a cylinder of the engine configured to sense pressure fluctuations in the cylinder of the engine;
the engine operating parameters configured such that the cylinder of the engine is more susceptible to pre-ignition than other cylinders of the engine; and
the corrective action instructions to reduce a flow of a gaseous fuel to the engine.

9. The system of claim 1 further comprising:
the sensor system comprising a vibration sensor operatively connected to a cylinder of the engine and configured to sense vibration fluctuations in the cylinder of the engine;
the engine operating parameters configured such that the cylinder of the engine is more susceptible to pre-ignition than other cylinders of the engine; and
the corrective action instructions to reduce a flow of a gaseous fuel to the engine.

10. A process for adjusting a gaseous fuel supplementation system for a diesel engine comprising:
sensing at least one combustion chamber operational condition in at least one combustion chamber of the engine with a sensor system;
relaying operational condition data to a control module;
identifying the existence of an impending pre-detonation condition from the operational condition data; and
reducing the flow of gaseous fuel to the engine to prevent pre-ignition.

11. The process of claim 10 wherein sensing the at least one combustion chamber operational condition comprising:
sensing pressure levels with a pressure sensor operatively connected to at least one cylinder of the engine.

12. The process of claim 10 wherein sensing the at least one combustion chamber operational condition comprising:
sensing vibration levels with a vibration sensor operatively connected to at least one cylinder of the engine.

13. The process of claim 10 further comprising:
configuring the at least one combustion chamber of the engine to be more susceptible to pre-ignition than other cylinders of the engine; and
sensing pressure levels with a pressure sensor operatively connected to the at least one cylinder of the engine.

14. The process of claim 10 further comprising:
configuring the at least one combustion chamber of the engine to be more susceptible to pre-ignition than other cylinders of the engine; and
sensing vibration levels with a vibration sensor operatively connected to the at least one cylinder of the engine.

15. A process for adjusting a gaseous fuel supplementation system for a diesel engine comprising:
sensing a combustion chamber operational condition in at least one combustion chamber of the engine with a sensor system;
relaying combustion chamber operational condition data to a control module;
identifying anticipated gaseous fuel flow rates based on combustion chamber operational data;
sensing an impending pre-detonation condition in at least one combustion chamber of the engine with a sensor system; and
adjusting the flow of gaseous fuel based on the status of the pre-ignition condition.

16. The process of claim 15 wherein sensing a combustion chamber operational condition further comprises:
sensing pressure levels with a pressure sensor operatively connected to the at least one cylinder of the engine.

17. The process of claim 15 wherein sensing a combustion chamber operational condition further comprises:
sensing vibration levels with a vibration sensor operatively connected to the at least one cylinder of the engine.

18. The process of claim 15 wherein sensing a combustion chamber operational condition further comprises:
configuring the at least one combustion chamber of the engine to be more susceptible to pre-ignition than other cylinders of the engine; and
sensing pressure levels with a pressure sensor operatively connected to the at least one cylinder of the engine.

19. The process of claim 15 wherein sensing a combustion chamber operational condition further comprises:
configuring the at least one combustion chamber of the engine to be more susceptible to pre-ignition than other cylinders of the engine; and
sensing vibration levels with a vibration sensor operatively connected to the at least one cylinder of the engine.

20. The process of claim 15 further comprises:
sensing a combustion chamber operational condition comprises sensing pressure levels with a pressure sensor operatively connected to the at least one cylinder of the engine;
configuring the at least one combustion chamber of the engine to be more susceptible to pre-ignition than other cylinders of the engine; and
sensing pressure levels with the pressure sensor operatively connected to the at least one cylinder of the engine.
